(19) United States
(12) Patent Application Publication
(10) Pub. No.: US 2023/0336251 A1
(43) Pub. Date: Oct. 19, 2023

(54) Underwater Antenna

(71) Applicant: ELAC SONAR GMBH, Kiel (DE)

(72) Inventors: Tim CLAUSSEN, Grob Vollstedt (DE); Ralf SIEGFRIED, Bovenau (DE)

(21) Appl. No.: 18/025,561

(22) PCT Filed: Sep. 24, 2021
(86) PCT No.: PCT/DE2021/100777

§ 371 Date: Mar. 9, 2023

(30) Foreign Application Priority Data
Sep. 30, 2020 (DE) 102020125543.8

(51) Int. Cl. H04B 11/00

(52) U.S. Cl. CPC H04B 11/00

(57) ABSTRACT

A modular system for forming an underwater antenna, consisting of a multiplicity of acoustic transducer modules for converting an acoustic signal into an electrical signal, a multiplicity of preamplifier modules for electrically amplifying an electrical signal received from an acoustic transducer module, a multiplicity of digitization modules for converting an electrical signal received from a preamplifier module into a digital signal, a multiplicity of power supply modules for supplying electrical energy to at least one digitization module and one preamplifier module, wherein in each case an acoustic transducer module, a preamplifier module, a digitization module and a power supply module form a physical unit that forms a functional transducer unit (FTU), the modules in each case have at least one standardized data interface for connection to at least one of the other modules, and the digitization modules, in order to form an underwater antenna, each have a network interface for connection to a switch that functionally combines the transducers.

The invention relates to an underwater antenna. The invention relates in particular to an electro-acoustic underwater antenna for use in sonar systems on surface or underwater ships.

Underwater antennas are manufactured devices which, for example, are used in the navigation of ships or in the locating of underwater targets. These are comprised of at least one acoustic sound transducer and electronics connected thereto, which are respectively selected depending on the respective application case, adapted to the respective intended use, and connected to one another as a system. The hardware installation of the individual components takes place largely on site, that is to say on the ship, so that often a high installation and wiring cost is incurred.

It is therefore an object of the invention to create a simple underwater antenna which can be individually adapted to a plurality of cases.

According to the invention, this object is achieved by the modular system for forming an underwater antenna having the features of claim 1, and the underwater antenna having the features of claim 7. Each of the dependent claims describes advantageous embodiments of the invention.

The basic idea of the invention is to create an underwater antenna assembled from individual functional transducer units (FTU). The transducers consist here in particular of a hydro-acoustic sensor element, i.e. a suitably shaped piezoelectric element or a sensor element based on another physical principle, composed of an acoustic insulation system for shielding the sensor element from the emission of the boat hull, and of electronics which suitably prepare the electrical signals of the sensor element, digitizes them, and relays them in a digital protocol directly to a data processing system. Depending on the requirement, the FTU can be positioned as desired on a suitable carrier structure, and thus can be individually adapted to the system requirements in terms of size, number of channels, and distance between the sensor elements. A suitable cladding structure, e. g., a plastic final encapsulation, a fluid-filled enclosure, or another measure, make an underwater antenna from the arrangement of the FTU on a carrier structure.

A modular and individually adaptable underwater antenna with great flexibility is now achieved in that each FTU possesses a standardized digital interface (e.g., LAN). This digital interface preferably uses the DDS (data distribution service) standard, i.e. a middleware for data-centered communication with the publisher-subscriber concept.

The invention can thus be used universally for various already existing and even future sonar applications such as, for example, flank array, cylindrical array, intercept array, and others. Due to each individual hydroacoustic element being equipped with a standardized data-centered digital interface, the possibility results of processing sensor data of all FTUs, even spanning across different sonars, in a central data processing system and setting them in relation to one another. The temporal synchronization of the individual sensor data is effected via special network protocols, which produces the synchronicity of the time settings of the different FTUs. This can be the precision time protocol (PTP), for example.

The individual functional transducer units can be connected to the data processing system via a suitable network topology, for example a star, ring, linear, or even individual topology. The installation and wiring cost is thereby significantly reduced according to the invention.

It is thus also possible later on to connect the prespecified hardware to defined arrays by software means, for which a change in the wiring or new hardware would typically have needed to be created.

According to the invention, a modular system is thus proposed for forming an underwater antenna consisting of a plurality of acoustic transducer modules for converting an acoustic signal into an electrical signal, a plurality of preamplifier modules for electrically amplifying an electrical signal received from an acoustic transducer module, a plurality of digitization modules for converting an electrical signal received from a preamplifier module into a digital signal, a plurality of power supply modules for supplying electrical energy to at least one digitization module and one preamplifier module, wherein respectively an acoustic transducer module, a preamplifier module, a digitization module, and a power supply module form a physical unit forming a functional transducer unit (FTU); wherein the modules respectively have at least one standardized data interface for connection to at least one of the other modules; and the digitization modules, in order to form an underwater antenna, respectively have a network interface for connection to a switch that functionally combines the functional transducer units.

The system preferably has a carrier module which is configured to receive a plurality of FTUs, wherein the carrier module has a plurality of recesses which are in any case configured to be partially complementary to the FTU. The recesses are thereby particularly preferably arranged at a prespecified distance from one another.

The carrier module especially has an electrical and/or a network section interface for connecting the carrier module to the FTUs and to the switch functionally combining the FTU.

The carrier module further preferably has a prespecified configuration which aligns the FTU in a curved arrangement, so that the carrier module in any case partially predefines the directional characteristic of the underwater antenna.

Finally, it is preferably provided that at least the preamplifier module, the digitization module, and the power supply module in each case have a housing with connecting means for connecting the housings to one another.

Furthermore, an underwater antenna with a plurality of functional transducer units is proposed, wherein the functional transducer units are designed as a physical unit consisting of an acoustic transducer module for converting an acoustic signal into an electrical signal; a preamplifier module connected to the acoustic transducer module for electrically amplifying an electrical signal received from the acoustic transducer module; a digitization module connected to the preamplifier module for converting an electrical signal received from a preamplifier module into a digital signal; and a power supply module connected to the digitization module for supplying at least the digitization module and the preamplifier module with electrical energy; and the digitization modules are in each case connected by means of a network interface to a switch that functionally combines the functional transducer units.

The underwater antenna preferably has a carrier module with a plurality of recesses that accommodate the functional transducer units, which recesses are in any case designed to be partially complementary to said functional transducer units. In particular, the carrier module has an electrical and/or a network section interface for connecting the carrier module to the functional transducer units and to the switch that functionally combines the functional transducer units. It is most preferably provided that the carrier module has a configuration that aligns the functional transducer units in a curved arrangement.

The present invention thus enables maximum flexibility in the design and construction of an underwater antenna in a completely scalable system which can be realized in a simple manner as a smart hydrophone or as a smart hydrophone group by combining elements of a modular construction kit.

1. A modular system for forming an underwater antenna, comprising:
a plurality of acoustic transducer modules for converting an acoustic signal into an electrical signal,
a plurality of preamplifier modules for electrically amplifying an electrical signal received from an acoustic transducer module,
a plurality of digitization modules for converting an electrical signal received from a preamplifier module into a digital signal,
a plurality of power supply modules for supplying electrical energy to at least one digitization module and one preamplifier module,
wherein:
in each case an acoustic transducer module, a preamplifier module, a digitization module, and a power supply module form a physical unit that forms a functional transducer unit (FTU),
the modules in each case have at least one standardized data interface for connection to at least one of the other modules, and
the digitization modules, in order to form an underwater antenna, in each case have at least one network interface for connection to a switch that functionally combines the functional transducer units.

2. The modular system according to claim 1, further comprising a carrier module configured to receive a plurality of functional transducer units, wherein the carrier module has a plurality of recesses which are in any case partially complementary to the functional transducer units.

3. The modular system according to claim 2, wherein the recesses are arranged at a prespecified distance from one another.

4. The modular system according to claim 2, wherein the carrier module has an electrical and/or a network interface for connecting the carrier module to the functional transducer units and to the switch functionally combining the functional transducer units.

5. The modular system according to claim 2, wherein the carrier module has a configuration that aligns the functional transducer units in a curved arrangement.

6. The modular system according to claim 1, wherein at least the preamplifier module, the digitization module, and the power supply module in each case have a housing with a connector for connecting the housings to one another.

7. An underwater antenna with a plurality of functional transducer units, wherein:
the functional transducer units are designed as a physical unit comprising:
an acoustic transducer module for converting an acoustic signal into an electrical signal,
a preamplifier module connected to the acoustic transducer module for electrically amplifying an electrical signal received from the acoustic transducer module,
a digitization module, connected to the preamplifier module, for converting an electrical signal received from a preamplifier module into a digital signal, and
a power supply module connected to the digitization module for supplying at least the digitization module and the preamplifier module with electrical energy, and
the digitization modules are in each case connected by means of a network interface to a switch functionally combining the functional transducer units.

8. The underwater antenna according to claim 7, further comprising a carrier module having a plurality of recesses accommodating the functional transducer units, in any case designed to be partially complementary thereto.

9. The underwater antenna according to claim 8, wherein the carrier module has an electrical and/or a network interface for connecting the carrier module to the functional transducer units and to the switch functionally combining the functional transducer units.

10. The underwater antenna according to claim 8, wherein the carrier module has a configuration that aligns the functional transducer units in a curved arrangement.

11. The underwater antenna according to claim 9 wherein the carrier module has a configuration that aligns the functional transducer units in a curved arrangement.

12. The modular system according to claim 3, wherein the carrier module has an electrical and/or a network interface for connecting the carrier module to the functional transducer units and to the switch functionally combining the functional transducer units.

13. The modular system according to claim 3, wherein the carrier module has a configuration that aligns the functional transducer units in a curved arrangement.

14. The modular system according to claim 2, wherein at least the preamplifier module, the digitization module, and the power supply module in each case have a housing with connecting means for connecting the housings to one another.

15. The modular system according to claim 4, wherein the carrier module has a configuration that aligns the functional transducer units in a curved arrangement.

16. The modular system according to claim 3, wherein at least the preamplifier module, the digitization module, and the power supply module in each case have a housing with connecting means for connecting the housings to one another.

17. The modular system according to claim 4, wherein at least the preamplifier module, the digitization module, and the power supply module in each case have a housing with connecting means for connecting the housings to one another.

18. The modular system according to claim 5, wherein at least the preamplifier module, the digitization module, and the power supply module in each case have a housing with connecting means for connecting the housings to one another.
